(19) United States
(12) Patent Application Publication
(10) Pub. No.: US 2010/0042866 A1
(43) Pub. Date: Feb. 18, 2010

(54) Method and Apparatus for Adjusting a System Timer of a Mobile Station

(75) Inventor: Chih-Heng Shih, Taichung City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 12/192,361

(22) Filed: Aug. 15, 2008

(51) Int. Cl. G06F 1/12

(52) U.S. Cl. 713/600

(57) ABSTRACT

A method and an apparatus for adjusting a system timer of a mobile station (MS) are disclosed, wherein a clock cycle time of the system timer is of a predetermined length. The method comprises the following steps: detecting a frame boundary of a frame from a base station (BS), the frame is with a frame length; adjusting an interrupt signal of the system timer from a predetermined time to a time related to the frame; and adjusting the clock cycle time from the predetermined length to the frame length. The modified system timer of the MS is synchronized to a frame timing of the BS.

### CROSS-REFERENCES TO RELATED APPLICATIONS

Not applicable.

### BACKGROUND OF THE INVENTION

1. Field of the Invention

The present invention relates to a method and an apparatus for adjusting a system timer of a mobile station (MS). In particular, the present invention relates to a method and an apparatus for adjusting a system timer of an MS to be consisted with a time related to a frame from a base station (BS).

2. Descriptions of the Related Art

Over recent years, mobile stations (MSs), such as mobile phones and personal digital assistants (PDAs), are common equipment in wireless communication systems. MSs are usually designed to have many applications for assisting and entertaining users. System timers within MSs have to promptly generate interrupt signals to start or shut down the applications at the accurate time. In other words, an interrupt signal could be an external or internal request of a system timer, such as a central processing unit (CPU), which stops the present operation and informs the software of the MS to execute different tasks. When an MS generates too many interrupt signals, the performance of MS may decay.

Please refers to FIG. 1, which illustrates the method of a conventional MS for generating interrupt signals. A system timer interrupt signal STI, a downlink end interrupt signal DEI, and an uplink end interrupt signal UEI are generated within one single frame F1, wherein the system timer interrupt signal STI is used to trigger the system timer of the MS, the downlink end interrupt signal DEI is used to inform a software to execute some tasks related to a downlink frame, and an uplink end interrupt signal is used to inform the software to execute some tasks related to an uplink frame. The MS in FIG. 1 requires at least three interrupt signals within each frame F1. As the number of the interrupt signals increases, the performance of the MS may degrade by the overhead CPU.

Accordingly, it is important for the MS to reduce number of the interrupt signals being generated and enhance the power saving control.

### SUMMARY OF THE INVENTION

An objective of this invention is to provide a method for adjusting a system timer of an MS, so that the adjusted system timer is synchronized to a time related to a frame from a BS, wherein a clock cycle time of the system timer is of a predetermined length.

To achieve the above objective, the method comprises the following steps: (a) detecting a frame boundary of the frame from the BS, wherein the frame is of a frame length, (b) adjusting an interrupt signal of the system timer from a predetermined time to a time related to the frame, and (c) adjusting the clock cycle time from the predetermined length to the frame length. Hence, the adjusted system timer of the MS is synchronized to the time related to the frame of the BS.

Another objective of this invention is to provide an apparatus for adjusting a system timer of an MS, so that the adjusted system timer is synchronized to a time related to a frame from a BS, wherein a clock cycle time of the system timer is of a predetermined length.

To achieve the objective, the apparatus comprises a detection module and an adjustment module. The detection module is configured to detect a frame boundary of the frame from the BS, wherein the frame is of a frame length. The adjustment module is configured to adjust an interrupt signal of the system timer from a predetermined time to the time related to the frame and adjust the clock cycle time from the predetermined length to the frame length. Hence, the adjusted system timer of the MS is synchronized to the time related to the frame from the BS.

By having the aforementioned arrangements, the present invention adjusts the interrupt signal of a system timer of an MS to be synchronized to a time related to a frame from a BS. Afterwards, the modified system timer generates interrupt signals periodically. In the present invention, the number of interrupt signals is decreased compared to the prior art and results in a better performance.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a conventional MS generating interrupt signals;

FIG. 2 is an apparatus of this invention;

FIG. 3A illustrates the scheduled time instants for the MS to generate interrupt signals at time instant t4;

FIG. 3B illustrates the scheduled time instants for the MS to generate interrupt signals at time instant t6;

FIG. 3C illustrates the scheduled time instants for the MS to generate interrupt signals at time instant t13;

FIG. 3D illustrates the scheduled time instants for the MS to generate interrupt signals at time instant t24;

FIG. 4 illustrates the structure of the first frame;

FIG. 5A illustrates the scheduled time instants for the MS to generate interrupt signals at time instant t54;

FIG. 5B illustrates the scheduled time instants for the MS to generate interrupt signals at time instant t60;

FIG. 5C illustrates the scheduled time instants for the MS to generate interrupt signals at time instant t67;

FIG. 5D illustrates the scheduled time instants for the MS to generate interrupt signals at time instant t73;

FIG. 6 illustrates the flow chart of the method for adjusting the system timer of the MS;

FIG. 7A illustrates the consumed power for an apparatus (or method) with unsynchronized interrupt signals; and

FIG. 7B illustrates the consumed power for an apparatus (or method) with synchronized interrupt signals.

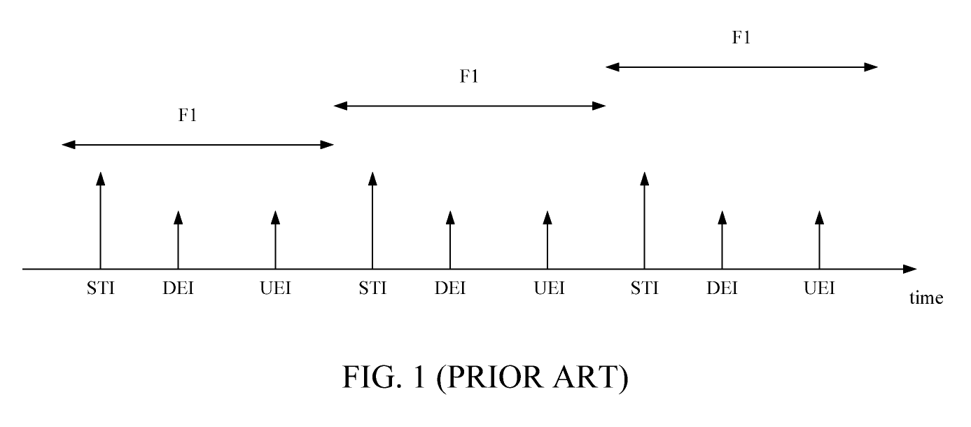

### DESCRIPTION OF THE PREFERRED EMBODIMENT

In the descriptions that follow, the present invention will be described in reference to the descriptions and examples about a method and an apparatus for adjusting a system timer of an MS. However, the descriptions and examples of the invention are not limited to any particular environment, application, or implementation. Therefore, the descriptions that follow are for purposes of illustration but not limitation.

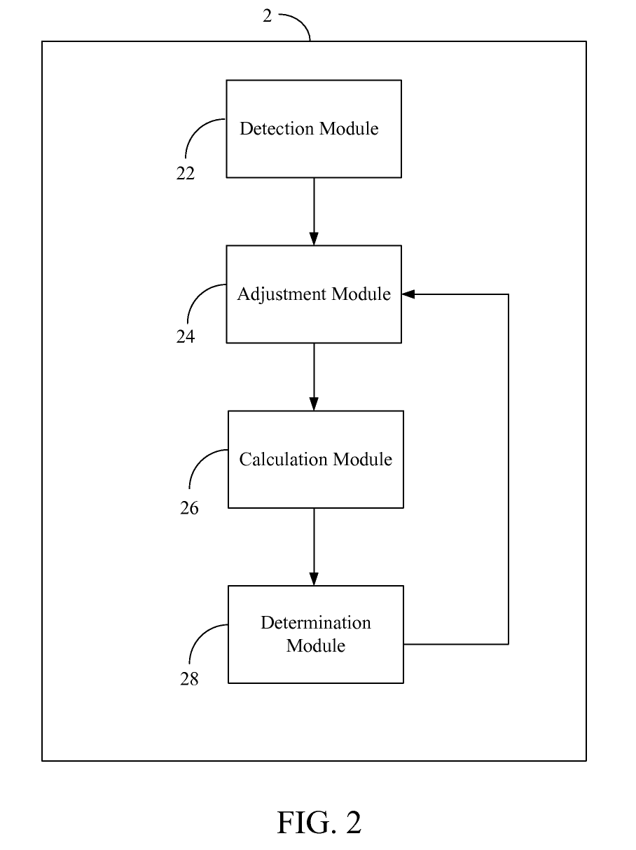

A first embodiment of this invention is an apparatus 2 for adjusting a system timer of an MS as shown in FIG. 2, wherein the apparatus 2 may be equipped within the MS. The system timer is configured to generate interrupt signals to inform the MS to run the applications at the accurate time instants. More specifically, when the MS is just turned on, its system timer generates one or several interrupt signals every a predetermined length of time. The following description will focus on the situation when the system timer generates one interrupt signal every the predetermined length of time.

The apparatus 2 comprises a detection module 22, an adjustment module 24, a calculation module 26, and a determination module 28. In this embodiment, the MS is served by a first BS, a second BS, and a third BS in sequence. It should be noted that the number of BSs, which is three in this embodiment, is used for illustration but not limitation. In other words, the MS may be served by fewer or more BSs in other embodiments.

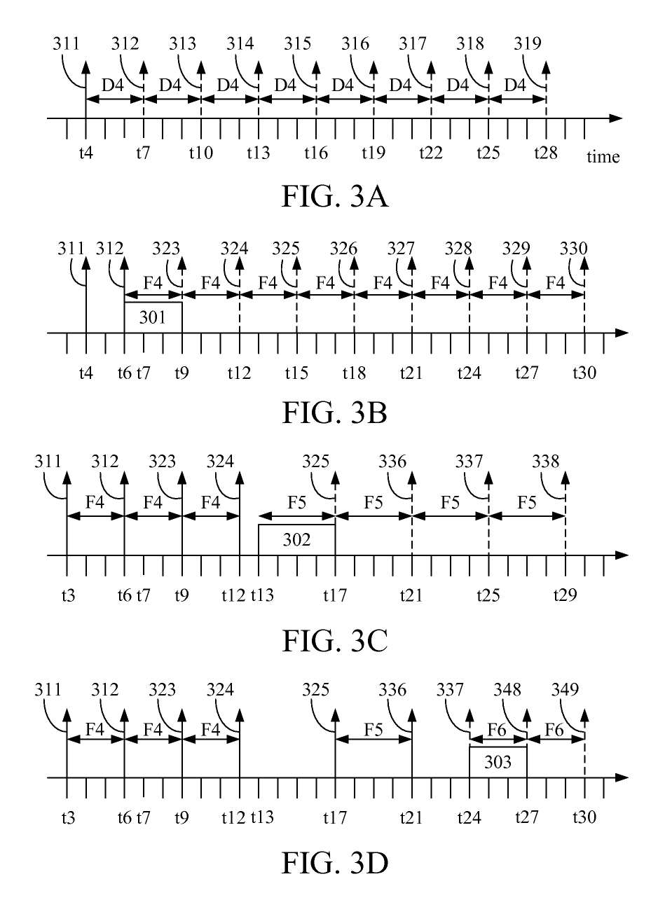

FIG. 3A illustrates the scheduled time instants for the MS to generate interrupt signals at time instant t4. At time instant t4, the MS is just turned on and a clock cycle time of the system timer is of the predetermined length D4. That is, an interrupt signal is generated by the apparatus 2 every the predetermined length D4 of time. From FIG. 3A, it can be seen that the interrupt signal 311 has been generated at time instant t4. On the other hand, the first interrupt signal 312 and the interrupt signals 313, 314, 315, 316, 317, 318, 319 are respectively scheduled to be generated at time instant t7 and time instants t10, t13, t16, t19, t22, t25, t28 (they are drawn by dashed arrows to represent the interrupt signals have not been generated yet).

FIG. 3B illustrates the scheduled time instants for the MS to generate interrupt signals at time instant t6. At time instant t6, the detection module 22 detects a first frame boundary of a first frame 301 from the first BS, wherein the first frame is of a first frame length F4. The first frame length F4 is generally shorter than the predetermined length D4; however for the illustration purpose, the first frame length F4 is equal to the predetermined length D4 in this embodiment. In fact, a predetermined length is normally smaller than a frame length. In other words, the two numbers may be unequal in other embodiments. That is, whether the first frame length F4 and the predetermined length D4 are equal or not is not the concern of the present invention.

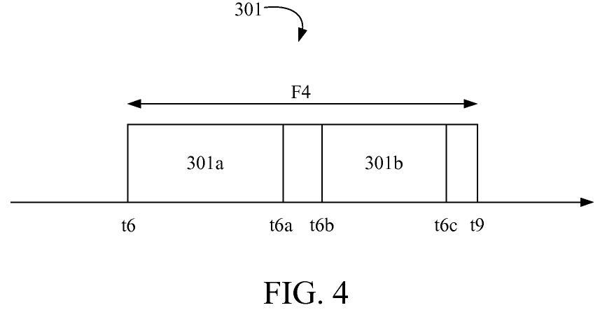

It should be noted that the next scheduled interrupt signal is the first interrupt signal 312, when the first frame boundary of the first frame 301 from the first BS. Then, the adjustment module 24 adjusts the first interrupt signal 312 of the system timer from a first predetermined time (i.e. time instant t7) to a time related to the first frame 301. Please refer to FIG. 4 for a detailed illustration of the structure of the first frame 301. The first frame 301 comprises a downlink frame 301a and an uplink frame 301b. The time related to the first frame 301 may be the time (i.e. time instant t6) corresponding to a start point of the first frame boundary (i.e. the beginning of the first frame 301), the time (i.e. time instant t9) corresponding to an end point of the first frame boundary (i.e. the ending of the first frame 301), the time (i.e. time instant t6) corresponding to a downlink start of the downlink frame 301a, the time (i.e. time instant t6a) corresponding to a downlink end of the downlink frame 301a, the time (i.e. time instant t6b) corresponding to an uplink start of the uplink frame 301b, or the time (i.e. time instant t6c) corresponding to an uplink end of the uplink frame 301b. Here, the adjustment module 24 adjusts the first interrupt signal 312 backward, specifically, the first predetermined time (i.e. time instant t7) is adjusted to the time (i.e. time instant t6) corresponding to a start point of the first frame boundary.

After adjusting the first interrupt signal 312 to be generated at time instant t6, the system timer generates the first interrupt signal 312. The adjustment module 24 also adjusts the clock cycle time of the system timer from the predetermined length D4 to the first frame length F4. Hence, the system timer is synchronized to the time related to the first frame 301 of the first BS after time instant t6. It means that the system timer will not generate the scheduled interrupt signals 313, 314, 315, 316, 317, 318, 319 at time instants t10, t13, t16, t19, t22, t25, t28 as scheduled in FIG. 3A. Instead, the system timer will generate an interrupt signal every the first frame length F4 of time after time instant t6. The time instant t6 is the start point of the first frame boundary. In other instance, the system timer may be synchronized at time instant t9 as the end point of the first frame boundary. By placing the interrupting signal at either the start or end point of the first frame boundary, the MS can perform synchronization in a better fashion because it is easier to observe the behavior of the BS. From FIG. 3B, it can be seen that the interrupt signals 323, 324, 325, 326, 327, 328, 329, 330 are respectively scheduled to be generated at time instants t9, t12, t15, t18, t21, t24, t27, t30 (they are drawn by dashed arrows to represent the interrupt signals have not been generated yet).

The calculation module 26 calculates a first time difference between a time corresponding to the first interrupt signal 312 (i.e. time instant t6) and the first predetermined time (i.e. time instant t7). More specifically, the calculation module 26 calculates the first time difference by subtracting the first predetermined time (i.e. time instant t7) from the time corresponding to the first interrupt signal (i.e. time instant t6) in this embodiment. The result of the subtraction equals negative one time unit. The first time difference is negative because the adjustment module 24 adjusts the first interrupt signal 312 backward. In other embodiments, the calculation module 26 may use other equations to derive the first time difference.

For the case of the MS needs to handover and be served by the second BS, the detection module 22 detects a second frame boundary of a second frame 302 from the second BS at time instant t13, wherein the second frame is of a second frame length F5.

FIG. 3C illustrates the scheduled time instants for the MS to generate interrupt signals at time instant t13. At time instant t13, the interrupt signals 311, 312, 323, 324 have been generated by the system timer. The next scheduled interrupt signal, called the second interrupt signal 325, was originally scheduled to be generated at time instant t15 as shown in FIG. 3B. The second interrupt signal 325 is adjusted due to the connection handover.

The determination module 28 determines that the first time difference is negative, so the adjustment module 24 will adjust the second interrupt signal 325 forward this time. More specifically, the adjustment module 24 adjusts the second interrupt signal 325 of the system timer from a second predetermined time t15 to a time related to the second frame according to the first time difference. The time related to the second frame is the time (i.e. time instant t17) corresponding to an end point of the second frame boundary. The adjustment module 24 also adjusts the clock cycle time from the first frame length F4 to the second frame length F5, so the system timer of the MS is synchronized to the second BS after time instant t17. This means that the second interrupt signal 325 is scheduled to be generated at time instant t17, and the interrupt signals 336, 337, 338 are respectively scheduled to be generated at time instants t21, t25, t29 (they are drawn by dashed arrows to represent the interrupt signals have not been generated yet).

The calculation module 26 calculates a second time difference between the time corresponding to the second interrupt signal (i.e. time instant t17) and the second predetermined time (i.e. time instant t15). More specifically, the calculation module 26 calculates the second time difference by subtracting the second predetermined time (i.e. time instant t15) from the time corresponding to the second interrupt signal (i.e. instant time t17), which leads to positive two time units. The calculation module 26 further calculates an accumulated time difference by adding the first time difference and the second time difference. In this embodiment, the accumulated time difference equals to positive one time unit.

After a while, the MS performs another connection handover to be served by the third BS. The detection module 22 detects a third frame boundary of a third frame 303 from the third BS at time instant t24, wherein the third frame is of a third frame length F6.

FIG. 3D illustrates the scheduled time instants for the MS to generate interrupt signals at time instant t24. At time instant t24, interrupt signals 311, 312, 323, 324, 325, 336 have been generated by the system timer. The next scheduled interrupt signal, called the third interrupt signal 337, was originally scheduled to be generated at time instant t25 as shown in FIG. 3C. However, the third interrupt signal 337 has to be adjusted due to the connection handover.

Because the accumulated time difference equals to positive one time unit, the determination module 28 determines that the accumulated time difference is non-negative. Hence, the adjustment module 24 will adjust the third interrupt signal 337 backward this time. The adjustment module 24 adjusts the third interrupt signal 337 to a time that corresponds to a start point of the third frame boundary, i.e. time instant t24. The adjustment module 24 further adjusts the clock cycle time from the second frame length F5 to the third frame length F6, therefore the system timer of the MS is synchronized to the frame timing of the third BS after time instant t24. This means that the third interrupt signal 337 is scheduled to be generated at time instant t24 and the interrupt signals 348, 349 are respectively scheduled to be generated at time instants t27, t30 (they are drawn by dashed arrows to represent the interrupt signals have not been generated yet).

The MS may perform a further connection handover if it is necessary. When the handover is performed again, the apparatus 2 will adjust the system timer according to a frame from the new BS in the similar approach. By having the aforementioned arrangement, the apparatus 2 of the first embodiment is able to adjust the system timer of the MS to be synchronized to the serving BS. Consequently, the MS does not have to generate many interrupt signals, so the performance of the MS can be increased and the consumed power can be reduced.

It is noted that the apparatuses in other embodiments may not be equipped with the calculation module 26 and the determination module 28. For apparatuses without the calculation module 26 and the determination module 28, the next scheduled interrupt signal can be adjusted either forward or backward without the consideration of the accumulated time difference.

A second embodiment of this invention is also an apparatus 2 for adjusting a system timer of an MS as shown in FIG. 2. In the second embodiment, the MS is also served by a first BS, a second BS, and a third BS in sequence. However, the adjustment module 24 in the second embodiment adjusts the first interrupt signal forward instead of backward.

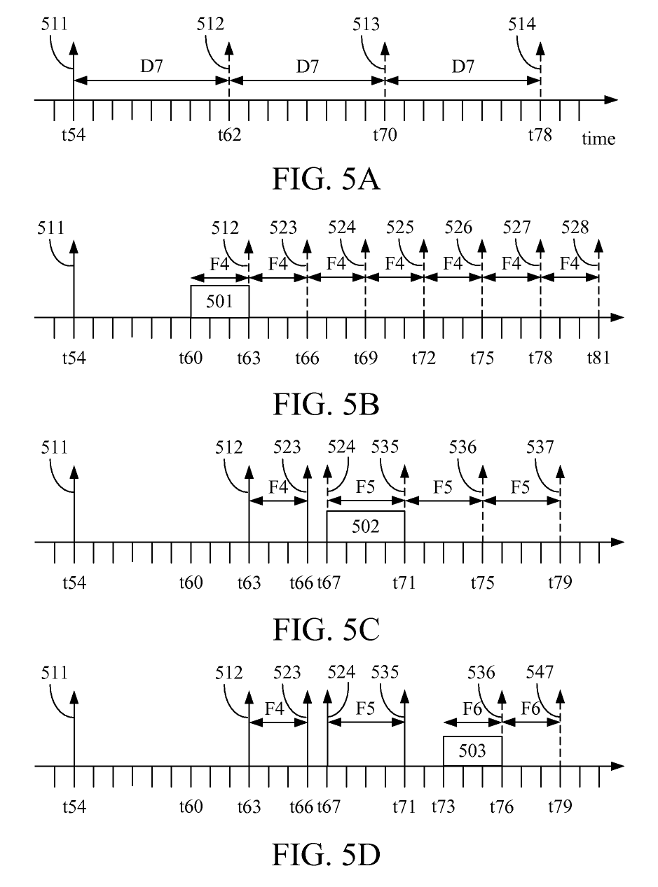

FIG. 5A illustrates the scheduled time instants for the MS to generate interrupt signals at time instant t54. It is assumed that the MS is turned on at time instant t50 (not shown). When the MS is just turned on, a clock cycle time of the system timer is of a first predetermined length D7. That is, an interrupt signal is generated by the apparatus 2 every the predetermined length D7 of time. From FIG. 5A, it can be seen that the interrupt signal 511 has been generated at time instant t54. On the other hand, the interrupt signals 512, 513, 514 are scheduled to be generated at time instants t62, t70, t78 (they are drawn by dashed arrows because they are not generated yet). It is noted that the word “first” of “the first interrupt signal 511” is used for description only.

FIG. 5B illustrates the scheduled time instants for the MS to generate interrupt signals at time instant t60. At time instant t60, the detection module 22 detects a first frame boundary of a first frame 501 from the first BS, wherein the first frame 501 is of a first frame length F4. The adjustment module 24 adjusts the next scheduled interrupt signal, called the first interrupt signal 512, of the system timer from a first predetermined time (i.e. time instant t62) to a time related to the first frame. More specifically, the time related to the first frame is a time corresponding to an end point of the first frame boundary (i.e. time instant t63) in this embodiment as shown in FIG. 5B. The adjustment module 24 also adjusts the clock cycle time from the predetermined length D7 to the first frame length F4. Hence, the adjusted system timer is synchronized to the frame timing of the first BS after time instant t63. This means that the system timer will not generate the first interrupt signal 512 and the scheduled interrupt signals 513, 514 respectively at time instant t62 and time instants t70, t78. On the contrary, the system timer will generate the first interrupt signal 512 at time instant 63 and other interrupt signal every the first frame length F4 of time after time instant t63. From FIG. 5B, it can be seen that the interrupt signals 512, 523, 524, 425, 526, 527, 528 are respectively scheduled to be generated at time instants t63, t66, t69, t72, t75, t78, t81 (they are drawn by dashed arrows because they are not generated yet).

The calculation module 26 calculates a first time difference by subtracting the first predetermined time (i.e. time instant t62) from the time corresponding to the first interrupt signal (i.e. time instant t63), which leads to positive one time unit.

Next, the MS performs a connection handover to be served by the second BS. The detection module 22 detects a second frame boundary of a second frame 502 from the second BS at time instant t67, wherein the second frame 502 is of a second frame length F5 as shown in FIG. 5C. FIG. 5C illustrates the scheduled time instants for the MS to generate interrupt signals at time instant t67.

Since the first time difference equals to positive one time unit, the determination module 28 will determine that the first time difference is non-negative. Based on the determination result, the adjustment module 24 adjusts the next scheduled interrupt signal, called the second interrupt signal 524, of the system timer backward. More specifically, the second interrupt signal 524 is adjusted from a second predetermined time (i.e. time instant t69) as shown in FIG. 5B to a time corresponding to a start point of the second frame boundary (i.e. time instant t67) as shown in FIG. 5C. The adjustment module 22 also adjusts the clock cycle time from the first frame length F4 to the second frame length F5, so the system timer of the MS is synchronized to the second BS after time instant t67 as shown in FIG. 5C. This means that the second interrupt signal 524 is scheduled to be generated at time instant t67 and the interrupt signals 535, 536, 537 are respectively scheduled to be generated at time instants t71, t75, t79 (they are drawn by dashed arrows because they are not generated yet).

The calculation module 26 calculates a second time difference by subtracting the second predetermined time (i.e. time instant t69) from the time corresponding to the second interrupt signal (i.e. time instant t67). The second time difference equals negative two time units. The calculation module 26 further calculates an accumulated time difference by adding the first time difference and the second time difference, which leads to negative one time unit.

After a while, the MS performs another connection handover to be served by the third BS. The detection module 22 detects a third frame boundary of a third frame 503 from the third BS at time instant t73, wherein the third frame 503 is of a third frame length F6 as shown in FIG. 5D.

FIG. 5D illustrates the scheduled time instants for the MS to generate interrupt signals at time instant t73. Because the accumulated time difference equals negative one time unit, the determination module 28 determines that the accumulated time difference is negative. Hence, the adjustment module 24 adjusts the next scheduled interrupt signal, called the third interrupt signal 536, of the system timer from time instant t75 as shown in FIG. 5C to a time corresponding to an end point of the third frame boundary (i.e. time instant t76) as shown in FIG. 5D. The adjustment module 24 further adjusts the clock cycle time from the second frame length F5 to the third frame length F6. Therefore, the system timer of the MS is synchronized to the frame timing of the third BS after time instant t76. This means that the third interrupt signal 536 is scheduled to be generated at time instant t76, and the interrupt signal 547 is scheduled to be generated at time instants t79 (they are drawn by dashed arrows because they are not generated yet).

Like the first embodiment, the MS may perform a further connection handover if it is necessary. When the handover is performed again, the apparatus 2 will adjust the system timer according to a frame from the new BS in the similar approach. Furthermore, the adjustment may be made according to the accumulated time difference. More specifically, when the accumulated time difference is negative, the next scheduled interrupt signal is adjusted forward. On the other hand, when the accumulated time difference is non-negative, the next scheduled interrupt signal is adjusted backward.

By having the aforementioned arrangements, the first and second embodiments are able to adjust the system timer of the MS to be synchronized to serving the BS. Consequently, the MS does not have to generate many interrupt signals, so the performance of the MS can be increased and the consumed power can be reduced.

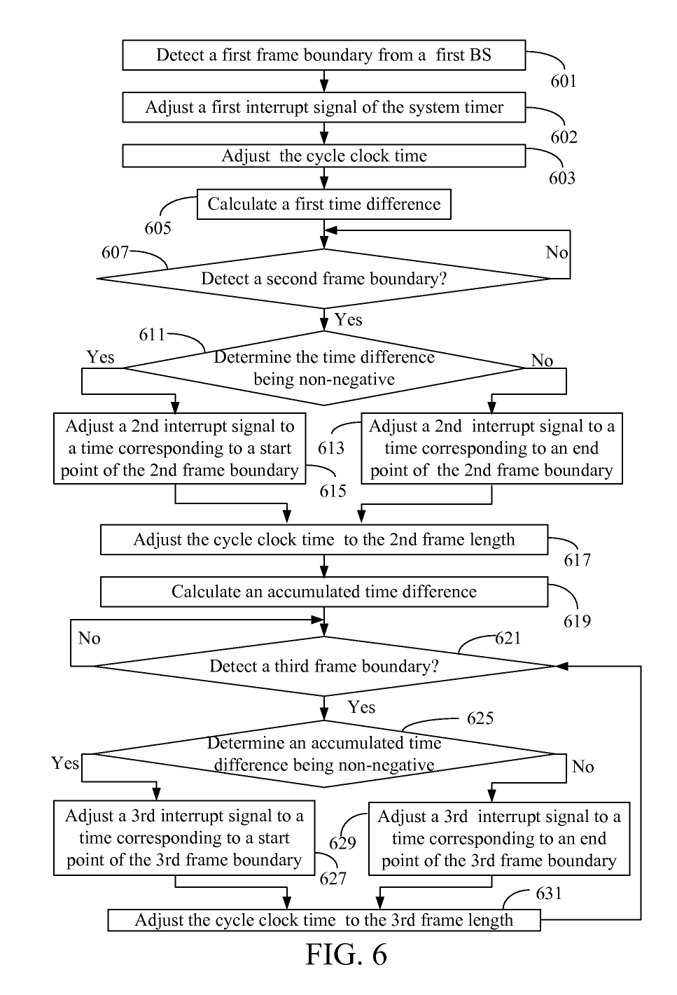

A third embodiment of the present invention is a method for adjusting a system timer of an MS, wherein a clock cycle time of the system timer is of a predetermined length. The method may be applied to the apparatus 2 described in the first and the second embodiments. Furthermore, the apparatus 2 may be equipped within the MS. For better understanding, please refer to FIG. 6 for the flow char of the method.

Initially in step 601, the method detects a first frame boundary of a first frame from the first BS, wherein the first frame is of a first frame length. Then, in steps 602 and 603, the method adjusts a first interrupt signal of the system timer from a first predetermined time to a time related to the first frame and adjusts the clock cycle time from the predetermined length of the first frame length. The time related to the first frame may be a time corresponding to a start point of the first frame boundary, a time corresponding to an end point of the first frame boundary, or a time corresponding to one of a downlink start, a downlink end, an uplink start, and an uplink end of the first frame.

In step 605, a first time difference between a time corresponding to the first interrupt signal and the first predetermined time is calculated. More specifically, the calculating step 605 calculates the first time difference by subtracting the first predetermined time from the time corresponding to the first interrupt signal.

In step 607, the method determines whether a second frame boundary of a second frame from a second BS is detected, wherein the second frame is of a second frame length. In other words, the step determines whether handovers to the second BS. If the MS does not detect the second frame boundary, the method will execute the step 607 again after a predetermined period of time. If the result in step 607 is yes, the method executes step 611 to determine whether the first time difference is non-negative. If the first time difference is not non-negative (i.e. negative) in step 611, a second interrupt signal of the system timer is adjusted from a second predetermined time to a time corresponding to an end point of the second frame boundary in step 613. If the first time difference is non-negative (i.e. positive or zero), a second interrupt signal of the system timer is adjusted from a second predetermined time to a time corresponding to a start point of the second frame boundary in step 615. Then, the method executes step 617 to adjust the clock cycle time from the first frame length to the second frame length. In step 619, the method calculates a second time difference between a time corresponding to the second interrupt signal and the second predetermined time to calculate an accumulated time difference by adding the first time difference and the second time difference.

Next, the method executes step 621 to determine if the MS detects a third frame boundary of a third frame from a third BS, wherein the third frame is of a third frame length. This means that the step detects whether the MS handovers to a third BS. If the result in step 621 is no, the method returns to the step 621 again after a while. If the result in step 621 is yes, the method determines whether the accumulated time difference is non-negative in step 625. If the accumulated time difference is non-negative, a third interrupt signal of the system timer is adjusted to a time corresponding to a start point of the third frame boundary in step 627. If the accumulated time difference is not non-negative (i.e. positive or zero), a third interrupt signal of the system timer is adjusted to a time corresponding to an end point of the third frame boundary in step 629. Next, the clock cycle time is adjusted from the second frame length to the third frame length in step 631.

The method may further determines whether a frame boundary from another BS is detected, i.e. determines whether the MS handovers to another BS. If it is yes, the method will adjust the system timer according to the frame from the new BS in the similar approach. In contrast to the conventional method, the interrupt signal would not be redundantly wastes since the system timer of the MS is synchronized to the frame timing of the BS as illustrated above.

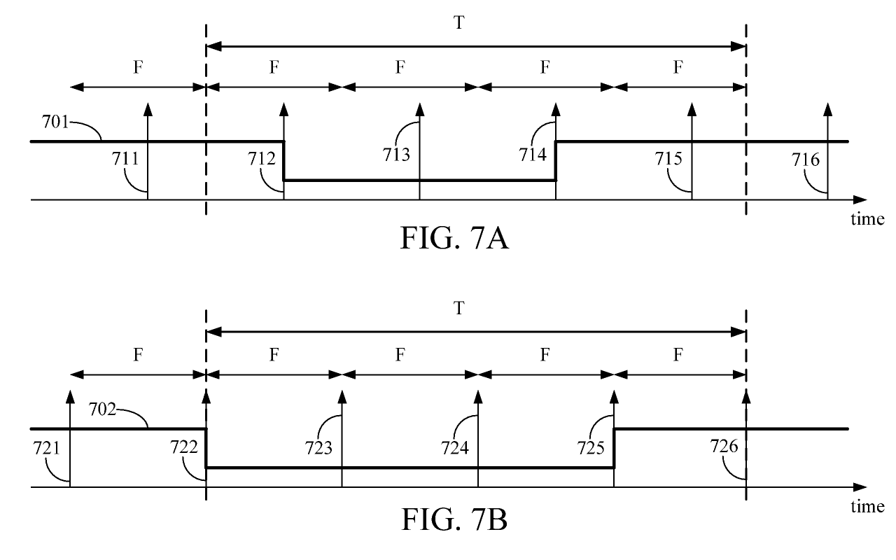

In addition, another objective of the present invention for the system timer of the MS synchronizing to the frame timing of the BS is to provide the advantage of power saving. FIG. 7A and FIG. 7B illustrate the consumed powers 701, 702 for an apparatus (or method) with unsynchronized interrupt signals and for an apparatus (or method) with synchronized interrupt signals, respectively. In FIG. 7A, interrupt signals 711, 712, 713, 714, 715, 716 are not synchronized to frame boundaries of the frames F. During a power saving period T, the apparatus (or method) with unsynchronized interrupt signals can only lower the consumed power 701 until the time corresponding to the interrupt signal 712. The consumed power 701 has to be raised at the time corresponding to the interrupt signal 714. In FIG. 7B, interrupt signals 721, 722, 723, 724, 725, 726 are synchronized to the frame boundaries of the frames F. Therefore, at the beginning of the power saving period, i.e. the time corresponding to the interrupt signal 722, the consumed power 702 can be immediately lowered. The consumed power 702 can be raised until the time corresponding to the interrupt signal 725. From FIG. 7A and FIG. 7B, it can be seen that the apparatus (or method) with synchronized interrupt signal consumes less power, which means saving more power during the power saving period T.

Accordingly, the present invention can adjust the system timer of the MS to be synchronized to the frame timing by adjusting interrupt signals to the time related to the frame of the BS. In the above embodiments, the times related to the frames (i.e. the first frame, second frame, and third frame) are mainly referred to as the time corresponding to the frame boundaries (i.e. the first frame boundary, second frame boundary, and third frame boundary) and the frame lengths after the frame boundaries (i.e. the first frame length after the first frame boundary, the second frame length after the second frame boundary, and the third frame length after the third frame boundary). However, it should be noted that they can be a time corresponding to one of a downlink start, a downlink end, an uplink start, and an uplink end of the frame of the BS. Hence, the number of the interrupt signals is able to be reduced, and the power can be saved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for adjusting a system timer of a mobile station (MS), a clock cycle time of the system timer being of a predetermined length, the method comprising the steps of:
detecting a first frame boundary of a first frame from a first base station (BS), the first frame being of a first frame length;
adjusting a first interrupt signal of the system timer from a first predetermined time to a time related to the first frame; and
adjusting the clock cycle time from the predetermined length to the first frame length.

2. The method of claim 1, wherein the time related to the first frame is a time corresponding to a start point of the first frame boundary.

3. The method of claim 1, wherein the time related to the first frame is a time that is an end point of the first frame boundary.

4. The method of claim 1, wherein the time related to the first frame is a time corresponding to one of a downlink start, a downlink end, an uplink start, and an uplink end of the first frame.

5. The method of claim 1, further comprising the steps of:
calculating a first time difference between a time corresponding to the first interrupt signal and the first predetermined time.

6. The method of claim 5, wherein the calculating step calculates the first time difference by subtracting the first predetermined time from the time corresponding to the first interrupt signal.

7. The method of claim 6, further comprising the steps of:
detecting a second frame boundary of a second frame from a second base station (BS), the second frame being with a second frame length;
adjusting a second interrupt signal of the system timer from a second predetermined time to a time related to the second frame; and
adjusting the clock cycle time from the first frame length to the second frame length.

8. The method of claim 7, further comprising the step of:
determining that the first time difference being negative;
wherein the time related to the second frame is a time corresponding to an end point of the second frame boundary.

9. The method of claim 7, further comprising the step of:
determining that the first time difference being non-negative;
wherein the time related to the second frame is a time corresponding to a start point of the second frame boundary.

10. The method of claim 7, further comprising the steps of:
calculating a second time difference between a time corresponding to the second interrupt signal and the second predetermined time;
calculating an accumulated time difference by adding the first time difference and the second time difference;
detecting a third frame boundary of a third frame from a third BS, the third frame being with a third frame length;
determining that the accumulated time difference being negative;
adjusting a third interrupt signal of the system timer to a time corresponding to an end point of the third frame boundary; and
adjusting the clock cycle time from the second frame length to the third frame length.

11. The method of claim 7, further comprising the steps of:
calculating a second time difference between a time corresponding to the second interrupt signal and the second predetermined time;
calculating an accumulated time difference by adding the first time difference and the second time difference;
detecting a third frame boundary of a third frame from a third BS, the third frame being with a third frame length;
determining that the accumulated time difference being non-negative;
adjusting a third interrupt signal of the system timer to a time corresponding to a start point of the third frame boundary; and
adjusting the clock cycle time from the second frame length to the third frame length.

12. An apparatus for adjusting a system timer of an MS, a clock cycle time of the system timer being of a predetermined length, the apparatus comprising:
a detection module for detecting a first frame boundary of a first frame from a first BS, the first frame being of a first frame length;
an adjustment module for adjusting a first interrupt signal of the system timer from a first predetermined time to a time related to the first frame and for adjusting the clock cycle time from the predetermined length to the first frame length.

13. The apparatus of claim 12, wherein the time related to the first frame is a time corresponding to a start point of the first frame boundary.

14. The apparatus of claim 12, wherein the time related to the first frame is a time that is an end point of the first frame boundary.

15. The apparatus of claim 12, wherein the time related to the first frame is a time corresponding to one of a downlink start, a downlink end, an uplink start, and an uplink end of the first frame.

16. The apparatus of claim 12, further comprising:
a calculation module for calculating a first time difference between a time corresponding to the first interrupt signal and the first predetermined time.

17. The apparatus of claim 16, wherein the calculation module calculates the first time difference by subtracting the first predetermined time from the time corresponding to the first interrupt signal.

18. The apparatus of claim 17, wherein the detection module further detects a second frame boundary of a second frame from a second BS, the second frame is of a second frame length, the adjustment module further adjusts a second interrupt signal of the system timer from a second predetermined time to a time related to the second frame, and further adjusts the clock cycle time from the first frame length to the second frame length.

19. The apparatus of claim 18, further comprising:
a determination module for determining that the first time difference being negative;
wherein the time related to the second frame is a time corresponding to an end point of the second frame boundary.

20. The apparatus of claim 18, further comprising:
a determination module for determining that the first time difference being non-negative;
wherein the time related to the second frame is a time corresponding to a start point of the second frame boundary.

21. The apparatus of claim 18, wherein
the calculation module further calculates a second time difference between a time corresponding to the second interrupt signal and the second predetermined time and further calculates an accumulated time difference by adding the first time difference and the second time difference,
the detection module further detects a third frame boundary of a third frame from a third BS, the third frame is of a third frame length,
the determination module further determines that the accumulated time difference is negative, and
the adjustment module further adjusts a third interrupt signal of the system timer to a time corresponding to an end point of the third frame boundary, and further adjusts the clock cycle time from the second frame length to the third frame length.

22. The apparatus of claim 18, wherein
the calculation module further calculates a second time difference between a time corresponding to the second interrupt signal and the second predetermined time and further calculates an accumulated time difference by adding the first time difference and the second time difference,
the detection module further detects a third frame boundary of a third frame from a third BS, the third frame is of a third frame length,
the determination module further determines that the accumulated time difference is non-negative, and
the adjustment module further adjusts a third interrupt signal of the system timer to a time corresponding to a start point of the third frame boundary and further adjusts the clock cycle time from the second frame length to the third frame length.
